(19) United States
(12) Patent Application Publication
(10) Pub. No.: US 2025/0233155 A1
(43) Pub. Date: Jul. 17, 2025

(54) Negative Electrode, Lithium-Ion Secondary Battery, and Method of Producing Negative Electrode

(71) Applicant: TOYOTA JIDOSHA KABUSHIKI KAISHA, Toyota-shi Aichi-ken (JP)

(72) Inventor: Naoki OSADA, Toyota-shi Aichi-ken (JP)

(73) Assignee: TOYOTA JIDOSHA KABUSHIKI KAISHA, Toyota-shi Aichi-ken (JP)

(21) Appl. No.: 19/017,998

(22) Filed: Jan. 13, 2025

(30) Foreign Application Priority Data
Jan. 16, 2024 (JP) 2024-004403

(51) Int. Cl. H01M 4/62; H01M 4/02; H01M 4/04; H01M 4/133; H01M 4/1393; H01M 10/0525

(52) U.S. Cl. CPC H01M 4/628; H01M 4/0404; H01M 4/133; H01M 4/1393; H01M 10/0525; H01M 2004/027

(57) ABSTRACT

A negative electrode includes: a negative electrode current collector; and a negative electrode active material layer, wherein the negative electrode active material layer includes a first active material, a second active material, an ion conductive polymer, and a conductive material, and the negative electrode active material layer has a structure provided with a void around the first active material.

### CROSS REFERENCE TO RELATED APPLICATIONS

This nonprovisional application is based on Japanese Patent Application No. 2024-004403 filed on Jan. 16, 2024 with the Japan Patent Office, the entire contents of which are hereby incorporated by reference.

### BACKGROUND

### Field

The present disclosure relates to a negative electrode, a lithium-ion secondary battery, and a method of producing a negative electrode.

### Description of the Background Art

Japanese Patent Laying-Open No. 2021-48106 discloses an active material for a secondary battery in which silicon, which is a negative electrode active material, is coated with polyethylene oxide, which is a polar polymer, to form a negative electrode composite material containing a conductive material, thereby having a sufficient capacity and desirable cycling performance.

### SUMMARY

In Japanese Patent Laying-Open No. 2021-48106, the cycling performance are improved by coating silicon with polyethylene oxide, but there is room for improvement.

An object of the present disclosure is to suppress an influence of expansion and contraction due to charging/discharging cycles and to suppress a decrease in capacity retention.

[1] A negative electrode comprising:
a negative electrode current collector; and
a negative electrode active material layer, wherein
the negative electrode active material layer includes a first active material, a second active material, an ion conductive polymer, and a conductive material, and
the negative electrode active material layer has a structure provided with a void around the first active material.

As compared with the second active material, the first active material is large in expansion and contraction due to charging/discharging, with the result that electrode cracking is likely to occur to result in decreased cycling performance. To address this, the negative electrode active material layer has the structure provided with the void around the first active material so as to suppress occurrence of electrode cracking even when the first active material is expanded and contracted. Thus, the influence of expansion and contraction of the first active material is reduced, with the result that improvement in cycling performance such as a capacity retention is expected.

[2] The negative electrode according to [1], wherein the ion conductive polymer is polyethylene oxide.

[3] The negative electrode according to [1] or [2], wherein
a ratio of an area of the void in the negative electrode active material layer is 30% or less, and
a ratio of an area of the void around the first active material to the area of the void in the negative electrode active material layer is 40% or more.

[4] A lithium-ion secondary battery comprising the negative electrode according to any one of [1] to [3].

[5] A method of producing a negative electrode, the method comprising:
forming a first particle by mixing and drying a first active material, an ion conductive polymer, and a conductive material;
forming a second particle by mixing the first particle and a second active material;
forming a negative electrode active material precursor layer by applying a liquid coating material to a negative electrode current collector, the liquid coating material being obtained by dissolving the second particle in a solvent; and
forming a negative electrode active material layer by bringing the negative electrode active material precursor layer into contact with an organic solvent, wherein
the negative electrode active material layer is provided with a void around the first active material.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing an example of a negative electrode of the present embodiment.

FIG. 2 is a schematic flowchart showing an example of a method of producing a negative electrode according to the present embodiment.

FIG. 3 is a schematic view showing an example of the lithium-ion secondary battery of the present embodiment.

FIG. 4 is a graph showing capacity retentions after 100 cycles in batteries No. 1 and No. 2.

FIG. 5 is a graph showing the expansion ratio with respect to the number of cycles in the batteries of No. 1 and No. 2.

### DESCRIPTION OF THE EMBODIMENTS

Hereinafter, embodiments of the present disclosure (hereinafter, also simply referred to as “the present embodiment”) and examples of the present disclosure (hereinafter, also simply referred to as “the present example”) will be described. However, the present embodiment and the present example do not limit the technical scope of the present disclosure.

### <Negative Electrode>

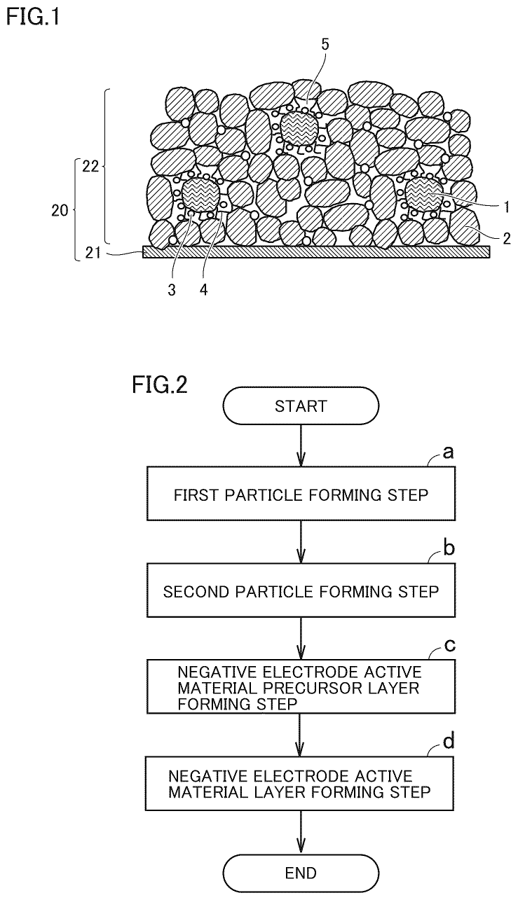

FIG. 1 is a schematic view showing an example of a negative electrode of the present embodiment. The negative electrode 20 includes a negative electrode current collector 21 and a negative electrode active material layer 22. The negative electrode current collector 21 may include, for example, a copper (Cu) foil, a nickel (Ni) foil, or the like.

### (Negative Electrode Active Material Layer)

The negative electrode active material layer 22 includes a first active material 1, a second active material 2, an ion conductive polymer 3, and a conductive material 4. The negative electrode active material layer 22 is provided with voids around the first active material 1.

The first active material 1 includes particles of simple substance or oxide of the active material containing an element selected from the group consisting of silicon (Si), aluminum (Al), and tin (Sn). In some embodiments, the first active material 1 contains Si from the viewpoint of capacity, and examples thereof include Si simple substance, silicon oxide, and silicon carbide composite.

The content of the first active material 1 in the negative electrode active material layer 22 is 5 mass % or more and 20 mass % or less.

In some embodiments, the average particle diameter (D50) of the first active material 1 is, for example, 3 μm or more and 20 μm or less, or 5 μm or more and 15 μm or less. In the present specification, the average particle diameter D50 is a particle diameter at which the accumulation of the frequency from the smaller particle diameter in the volume-based particle size distribution is 50%. The volume-based particle size distribution can be measured by a laser diffraction particle size distribution measuring apparatus.

The second active material 2 includes one or more particles selected from the group consisting of graphite, hard carbon, soft carbon, and carbon (C) such as amorphous coated graphite, or is one or more particles selected from the group. In some embodiments, the second active material 2 contains graphite, or consists of graphite. The graphite may be natural graphite or artificial graphite.

In some embodiments, the D50 of the second active material 2 is, for example, 5 μm or more and 15 μm or less, or 8 μm or more and 10 μm or less. In some embodiments, the D50 of the second active material 2 is smaller than the D50 of the first active material 1.

The content of the second active material 2 in the negative electrode active material layer 22 is 75 mass % or more and 95 mass % or less.

The ion conductive polymer 3 is a polymer that conducts lithium ions. The ion conductive polymer 3 is mainly supported on the first active material 1. The ion conductive polymer 3 is not particularly limited as long as it is a polymer that conducts lithium ions, and may be, for example, polyethylene oxide (PEO), polyvinyl alcohol (PVA), Nafion (registered trademark), vinylidene difluoride-hexafluoropropene copolymer (PVDF-HFP), or polymethylmethacrylate (PMMA). In some embodiments, the ion conductive polymer 3 contains PEO, or PEO.

The PEO may have a functional group. When PEO has a functional group, ionic conductivity is improved. Examples of the functional group include a carboxyl group, a sulfonate group, and a sulfonamide group. PEO may be modified with ethylene carbonate or complexed with lithium salts such as lithium bis(oxalato) borate (LiBOB). This improves the plasticity of PEO.

The molecular weight of PEO is not particularly limited, and is, for example, 20,000 or more and 1 million or less. In some embodiments, the molecular weight of PEO is relatively low.

The content of the ion conductive polymer 3 in the negative electrode active material layer 22 is 1% by mass or more and 5% by mass or less.

The conductive material 4 forms a conductive path. Examples of the conductive material 4 include carbon black (CB) (acetylene black (AB), Ketjen black (KB)), carbon nanotubes (CNT), and vapor-grown carbon fibers (VGCF).

The content of the conductive material 4 in the negative electrode active material layer 22 is 1% by mass or more and 5% by mass or less.

The negative electrode active material layer 22 has a structure provided with voids 5 (hereinafter, the voids around the first active material 1 are also referred to as “first voids”) around the first active material 1. Since the negative electrode active material layer 22 has the first voids 5, the influence of expansion and contraction of the first active material 1 is reduced, and as a result, improvement in cycling performance such as a capacity retention is expected. Here, the structure provided with void 5 around the first active material 1 is particularly a structure having a void between the first active material 1 and the second active material 2. Specifically, in a state where charging is not performed, the first active material 1 shrinks and the first voids 5 exist. On the other hand, in the charged state, the first active material 1 expands and fills at least a part of the first void 5.

Here, the term “around the first active material 1” refers to a region within a circle having a radius of a certain distance from the center of gravity of the first active material 1, and typically refers to a region within a circle having a radius of a distance twice the average particle diameter of the first active material 1 from the center of gravity of the first active material 1. For example, the periphery of the first active material 1 having an average particle diameter of 10 μm refers to a region within a circle having a radius of 20 μm from the center of gravity of the first active material 1.

The ion conductive polymer 3 and the conductive material 4 may be present so as to crosslink (bridge) the first active material 1 and the second active material 2 in the first void 5. The first void 5 may be a region where the ion conductive polymer 3 does not exist in a region surrounded by the first active material 1 and the second active material 2.

The negative electrode active material layer 22 may have voids other than the first voids 5. In some embodiments, the ratio of the area of voids in the negative electrode active material layer 22 is 30% or less. In some embodiments, the ratio of the area of the first voids 5 to the area of the voids in the negative electrode active material layer 22 is 40% or more. When the proportion of the area of the voids in the negative electrode active material layer 22 is 30% or less, it is considered that the proportion of the voids in the negative electrode active material layer 22 is low. When the ratio of the area of the first voids 5 to the area of the voids in the negative electrode active material layer 22 is 40% or more, it is considered that the ratio of the first voids 5 in the negative electrode active material layer 22 is high. Therefore, suppression of electrode cracking is expected while maintaining high capacitance. The ratio of the area of the voids in the negative electrode active material layer 22 may be 25% or less, and may be 20% or less. The ratio of the area of the voids in the negative electrode active material layer 22 may be 10% or more, and may be 15% or more. The ratio of the area of the first voids 5 to the area of the voids in the negative electrode active material layer 22 may be 50% or more, or may be 60% or more. The ratio of the area of the first voids 5 to the area of the voids in the negative electrode active material layer 22 may be 90% or less, or may be 80% or less. The ratio of the area of the voids in the negative electrode active material layer 22 is obtained by measuring the ratio of the area of the voids to the cross-sectional area when the negative electrode active material layer 22 is observed in a cross-section with a scanning electron microscope (SEM). The ratio of the area of the first voids 5 in the negative electrode active material layer 22 is obtained by measuring the ratio of the area of the voids between the first active material 1 and the second active material 2 when the negative electrode active material layer 22 is observed in a cross section by SEM.

The negative electrode active material layer 22 may further contain a binder, a thickener, or the like.

The binder may include, for example, polyvinylidene difluoride (PVdF), polytetrafluoroethylene (PTFE), styrene-butadiene rubber (SBR), or the like. The thickener may include, for example, carboxymethyl cellulose (CMC), methyl cellulose (MC), and the like.

The content of the binder and the thickener contained in the negative electrode active material layer 22 is, for example, 0.1 mass % or more and 5 mass % or less.

In some embodiments, the supported amount of the active material in the negative electrode active material layer 22 is 20 mg/cm² or more. When the supported amount of the active material is 20 mg/cm² or more, further improvement in cycling performance is expected. The “active material” includes both the first active material 1 and the second active material 2.

### <Method of Producing Negative Electrode>

FIG. 2 is a schematic flowchart of a method of producing a negative electrode according to the present embodiment. Hereinafter, “a method of producing a negative electrode in the present embodiment” may be simply referred to as “the production method”. The production method includes at least (a) a first particle forming step, (b) a second particle forming step, (c) a negative electrode active material precursor layer forming step, and (d) a negative electrode active material layer forming step.

### ((a) First Particle Forming Step)

In the first particle forming step, the first active material, the ion conductive polymer, and the conductive material are mixed with a solvent and dried to form first particles. The first particle includes a coating layer coated with an ion conductive polymer and a conductive material around the first active material.

The first active material, the ion conductive polymer, and the conductive material are dispersed in a solvent at a predetermined ratio to form a first aqueous solution. The solvent is not particularly limited as long as it can disperse the first active material, the ion conductive polymer, and the conductive material, and examples thereof include water. The first aqueous solution is subjected to particle pulverization and stirring and mixing by mechanical mixing device such as a mortar, a mixer, or a planetary ball mill, and dried to obtain first particles. The mixing conditions are not particularly limited, and are appropriately adjusted according to the desired thickness of the coating layer.

### ((b) Second Particle Forming Step)

In the second particle forming step, the second particles are formed by mixing the first particles obtained in the first particle forming step and the second active material. The second particle includes a second active material around the first particle.

For example, the second aqueous solution is prepared by dispersing the first particles and the second active material in a solvent (e.g., water). After stirring and mixing the second aqueous solution, the droplets are instantaneously dried by a method such as a spray drying method to obtain second particles. In some embodiments, in this step, the D50 of the second active material is smaller than the D50 of the first active material. Accordingly, the second particles are easily formed.

### ((c) Negative Electrode Active Material Precursor Layer Forming Step)

In the negative electrode active material precursor layer forming step, the negative electrode active material precursor layer is formed by coating the negative electrode current collector with a liquid coating material obtained by dispersing the second particles obtained in the second particle forming step in a solvent.

For example, a liquid coating material is prepared by dispersing the second particles in a solvent (for example, water). In addition to the second particles, a binder, a thickener, or the like may be mixed. A second active material and a conductive material may be further added. The liquid coating material is applied to the surface of the negative electrode current collector. For coating, for example, a doctor blade or a die coater is used. By drying the liquid coating material, a negative electrode active material precursor layer is formed. After drying, the negative electrode active material precursor layer may be compressed.

### ((d) Negative Electrode Active Material Layer Forming Step)

In the negative electrode active material layer forming step, the negative electrode active material precursor layer obtained in the negative electrode active material precursor layer forming step is brought into contact with an organic solvent to form a negative electrode active material layer.

For example, by immersing the negative electrode active material precursor layer in an organic solvent, the ion conductive polymer in the coating layer contained in the second particles is removed, and a first void is formed inside the second particles. As the organic solvent, a solvent capable of selectively dissolving the ion conductive polymer is used, and examples thereof include ethanol, acetonitrile, toluene, acetone, dichloromethane, hexane, and chloroform. All or a part of the ion conductive polymer contained in the second particles may be removed. The ratio at which the ion conductive polymer is removed is adjusted by appropriately adjusting the type of the organic solvent, the immersion time, and the like.

### <Lithium-Ion Secondary Battery>

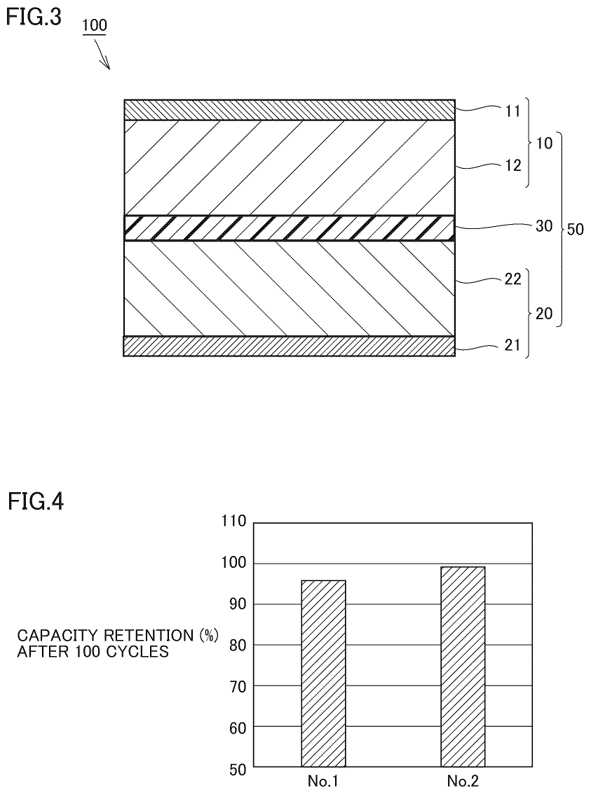

FIG. 3 is a schematic view showing an example of a lithium-ion secondary battery (hereinafter, the battery is also simply referred to as a “battery”) of the present embodiment. The battery 100 may include an exterior package (not illustrated). The exterior package may contain the power generation element 50 and an electrolyte solution (not shown). The exterior package may have any form. The exterior package may be, for example, a metal case or a pouch made of a metal foil laminate film. The exterior package may contain, for example, Al or the like.

The battery 100 includes a power generation element 50. The power generation element 50 may also be referred to as an electrode assembly or an electrode group. The power generation element 50 includes a positive electrode 10, a separator 30, and a negative electrode 20. The power generation element 50 has any structure. For example, the power generation element 50 may be of a wound type. The positive electrode 10, the separator 30, and the negative electrode 20 may all be strip-shaped sheets. The power generation element 50 may be formed, for example, by stacking the positive electrode 10, the separator 30 (first sheet), the negative electrode 20, and the separator 30 (second sheet) in this order. After winding, the power generation element 50 may be formed into a flat shape.

### (Positive Electrode)

The positive electrode 10 may include a positive electrode current collector 11 and a positive electrode active material layer 12. The positive electrode current collector 11 may include, for example, an aluminum (Al) foil or the like. The positive electrode active material layer 12 contains a positive electrode active material. The positive electrode active material layer 12 may further contain, for example, a conductive material, a binder, or the like.

The positive electrode active material may be in the form of particles, for example. The positive electrode active material may have a D50 of, for example, 1 μm or more and 30 μm or less. The positive electrode active material may contain, for example, at least one selected from the group consisting of LiCoO₂, LiNiO₂, LiMnO₂, Li(NiCoMn)O₂, and Li(NiCoAl)O₂. For example, “(NiCoMn)” in “Li(NiCoMn)O₂” indicates that the total composition ratio in parentheses is 1. The amount of individual component is freely set as long as the total is 1.

The conductive material may include, for example, AB or the like. The binder may include, for example, PVdF. The conductive material and the binder may be, for example, 0.1 mass % or more and 10 mass % or less with respect to the positive electrode active material layer 12.

### (Separator)

The separator 30 is porous. The separator 30 can permeate the electrolyte solution. The separator 30 separates the positive electrode 10 from the negative electrode 20. The separator 30 is electrically insulating. The separator 30 may include, for example, a polyolefin resin such as polyethylene (PE) or polypropylene (PP). The separator 30 may have, for example, a single-layer structure or a multilayer structure. The separator 30 may be substantially composed of, for example, a PE layer, or may be formed by stacking a PP layer, a PE layer, and a PP layer in this order.

### (Electrolyte Solution)

The electrolyte solution includes a solvent and a Li salt. The solvent is aprotic. The solvent may comprise any ingredient. The solvent may include, for example, at least one selected from the group consisting of ethylene carbonate (EC), dimethyl carbonate (DMC), and ethyl methyl carbonate (EMC).

The Li salt is a supporting electrolyte. The Li salt is dissolved in the solvent. The Li salt may contain, for example, at least one selected from the group consisting of LiPF₆, LiTFSI, and LiBF₄. The Li salt may have a molar concentration of, for example, 0.5 mol/L or more and 2.0 mol/L or less.

The electrolyte solution may further contain an optional additive. The electrolyte solution may contain, for example, 0.01 mass % or more and 5 mass % or less of an additive. The additive may include, for example, at least one selected from the group consisting of vinylene carbonate (VC), vinylethylene carbonate (VEC), and the like.

### EXAMPLES

### (No. 1)

As materials of the negative electrode, Si (D50: 10 μm) (5 mass %) as a first active material, artificial graphite (D50: 6 μm) (91.5 mass %) as a second active material, SBR (1 mass %) as a binder, CMC (1 mass %) as a thickener, and AB (1.5 mass %) as a conductive material were prepared. These materials were mixed in distilled water and kneaded using a kneader to obtain a negative electrode paste.

The obtained negative electrode paste was applied to the surface of a Cu foil as a negative electrode current collector using a doctor blade. After the application, the negative electrode paste was dried at 100° C. for 15 minutes and compressed by a roll press machine to obtain a negative electrode of No. 1. The amount of the active material supported on the negative electrode active material layer was 20 mg/cm², and the density of the negative electrode active material layer was 1.4 g/cm³.

As materials of the positive electrode, LiNi_{0.6}Co_{0.2}Mn_{0.2}O₂ (95 mass %) as a positive electrode active material, AB (2.5 mass %) as a conductive material, and PVdF (2.5 mass %) as a binder were prepared. These materials were mixed with N-methyl-2-pyrrolidone (NMP) and kneaded using a kneader to obtain a positive electrode paste.

The obtained positive electrode paste was applied to the surface of an Al foil as a positive electrode current collector using a doctor blade. After the application, the positive electrode paste was dried at 80° C. for 15 minutes and compressed by a roll press machine to obtain a positive electrode. The amount of the active material supported on the positive electrode active material layer was 38 mg/cm², and the density of the positive electrode active material layer was 3.2 g/cm³.

PE was prepared as a separator. The positive electrode and the negative electrode were alternately laminated with separators interposed therebetween to form a power generation element. The power generation element included four positive electrodes and five negative electrodes.

A pouch made of a laminate film was prepared as an exterior package. The power generation element was housed in the exterior package. As an electrolyte solution, a solution obtained by dissolving a supporting salt (LiPF₆) at a concentration of 1.2 mol/L in a mixed solvent containing EC, DMC, and EMC was prepared. The electrolyte solution was injected into the exterior package. After the electrolyte solution was injected, the exterior package was sealed under vacuum of −80 kPa. Thus, the battery No. 1 was produced.

### (No. 2)

As a material of the negative electrode, the same material as that of No. 1 was prepared except that PEO was used as an ion conductive polymer. The steps of dissolving Si, AB, and PEO in distilled water kept at 60° C., stirring the solution for 12 hours using a planetary ball mill, and drying the solution were repeated twice to obtain first particles. In the obtained first particles, a coating layer (thickness: 2.0 μm) composed of AB and PEO was formed around Si.

The obtained first particles and artificial graphite were mixed and instantaneously dried by a spray dryer to obtain second particles.

The obtained second particles, artificial graphite, SBR, and CMC were mixed in distilled water and kneaded using a kneader to obtain a negative electrode paste. The content ratio (mass %) of each material in the negative electrode paste is Si: AB: PEO: artificial graphite: SBR: CMC=5:1.25:0.25:91.5:1:1.

The obtained negative electrode paste was applied to the surface of a Cu foil as a negative electrode current collector using a doctor blade. After the application, the negative electrode paste was dried at 100° C. for 15 minutes and compressed by a roll press to obtain a negative electrode active material precursor layer.

The obtained negative electrode active material precursor layer was immersed in ethanol held at 30° C. for 15 minutes, and then washed to remove PEO, thereby forming voids around Si. Thus, a negative electrode No. 2 was obtained. The amount of the active material supported on the negative electrode active material layer was 20 mg/cm², and the density of the negative electrode active material layer was 1.3 g/cm³.

A battery of No. 2 was produced using the same material and method as those of the battery of No. 1, except that the negative electrode of No. 2 was used as the negative electrode.

### <Evaluation>

### (Voids)

In the negative electrode of No. 2, the ratio of the area of the voids in the negative electrode active material layer and the ratio of the area of the first voids to the area of the voids in the negative electrode active material layer were measured. Specifically, the negative electrode of No. 2 was subjected to a cross-section forming process using a cross-section polisher (registered trademark). Cross-sectional SEM images were taken by SEM. The cross-sectional SEM image was subjected to ternary processing to identify voids, and the ratio of the area of each void was measured. As a result, the ratio of the area of the voids in the negative electrode active material layer was 30%, and the ratio of the area of the first voids to the area of the voids in the negative electrode active material layer was 40%. In the negative electrode of No. 1, voids were present in the negative electrode active material layer, but voids were not unevenly distributed around Si.

### (Charge/Discharge Evaluation)

The battery of each No. was allowed to stand still in a thermostatic chamber at 40° C. The battery was charged to 4.2 V at 0.5 C. The battery was discharged to 3.0 V at 0.5 C with a 10 minute pause. The discharge capacity at this time is regarded as the “initial capacity”. Note that “C” is a symbol indicating a time rate. The current of 1 C flows through the rated capacity of the battery in one hour.

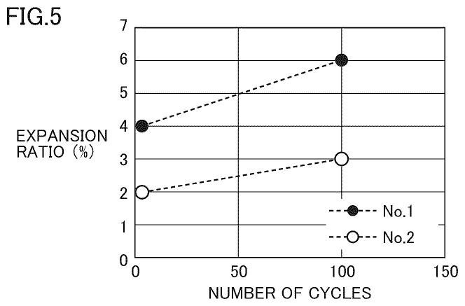

The cycle of charging, stopping, and discharging was defined as one cycle, and 100 cycles of charging and discharging were performed in the battery of each No. The discharge capacity at the 100th cycle was divided by the initial capacity to determine the capacity retention. The results are shown in FIG. 4.

### (Expansion Ratio)

A displacement gauge was placed directly above the restraining jig (metal plate). The change in the thickness of the battery due to the vertical movement of the battery accompanying charging and discharging was measured. The results are shown in FIG. 5. The expansion ratio at each time point is represented by T2/T1. T1 is the initial thickness of the battery at the time of assembly. T2 is the thickness of the battery at that time.

### <Results>

As shown in FIG. 4, the capacity retention of No. 2 is higher than that of No. 1. Further, as shown in FIG. 5, it can be seen that the increase in the expansion ratio was reduced in No. 2 as compared with No. 1. From the above, in No. 2, it is considered that the capacity retention is high and the influence of expansion and contraction of the negative electrode is reduced.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A negative electrode comprising:
a negative electrode current collector; and
a negative electrode active material layer, wherein
the negative electrode active material layer includes a first active material, a second active material, an ion conductive polymer, and a conductive material, and
the negative electrode active material layer has a structure provided with a void around the first active material.

2. The negative electrode according to claim 1, wherein the ion conductive polymer is polyethylene oxide.

3. The negative electrode according to claim 1, wherein
a ratio of an area of the void in the negative electrode active material layer is 30% or less, and
a ratio of an area of the void around the first active material to the area of the void in the negative electrode active material layer is 40% or more.

4. A lithium-ion secondary battery comprising the negative electrode according to claim 1.

5. A method of producing a negative electrode, the method comprising:
forming a first particle by mixing and drying a first active material, an ion conductive polymer, and a conductive material;
forming a second particle by mixing the first particle and a second active material;
forming a negative electrode active material precursor layer by applying a liquid coating material to a negative electrode current collector, the liquid coating material being obtained by dissolving the second particle in a solvent; and
forming a negative electrode active material layer by bringing the negative electrode active material precursor layer into contact with an organic solvent, wherein
the negative electrode active material layer is provided with a void around the first active material.
